(19) United States
(12) Patent Application Publication
(10) Pub. No.: US 2006/0011648 A1
(43) Pub. Date: Jan. 19, 2006

(54) Article discharging apparatus

(76) Inventor: Kazuhito Yoshitani, Tokyo (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/165,338

(22) Filed: Jun. 24, 2005

(30) Foreign Application Priority Data
Jun. 30, 2004 (JP) 194768/2004

(51) Int. Cl. G07F 11/00

(52) U.S. Cl. 221/288

(57) ABSTRACT

An article discharging apparatus of the present invention includes: a first tilting member for tilting the container; a second tilting member for further tilting the container that has been tilted by the first tilting member; and an article moving member arranged close to the second tilting member-and adapted to move the article. An article discharging apparatus according to another aspect of the present invention includes: a tilting member for tilting the container; and an article moving member arranged close to the tilting member and adapted to move the article. The tilting member includes a container moving member, a container fixing member, and a shutter portion for opening and closing at least a part of an opening of the container. The article discharging apparatus of the present invention can include a member for pushing out the article through a through-hole in a bottom portion of the container.

### BACKGROUND OF THE INVENTION

1. Field of the Invention

The present invention relates to an apparatus used to extract articles in a container and, in particular, to an article discharging apparatus making it possible to extract, for example, articles stacked together in a container, such as large envelopes, efficiently in a stacked state.

2. Description of the Related Art

Recently, it has become a widely exercised practice to obtain books, magazines, etc. through online marketing. Such books or magazines are delivered to the purchaser by mail or by a delivery service. Documents and magazines are accommodated in dedicated large envelopes. The post office or the home delivery company stacks these large envelopes in a container, and conveys the large envelopes by a conveying apparatus as disclosed, for example, in JP 2003-237926 A, sorting them out according to the delivery area by using a sorter. Usually, in performing the above operation, the operator manually extracts a plurality of large envelopes stacked together from a container, and supplies them to the sorter.

FIG. 1A and FIG. 1B are a front view and a side view of a conventional example of an envelope discharging apparatus used to extract large envelopes from a container. An envelope discharging apparatus 100 has a movable plate 110, an air cylinder 120 for rotating the movable plate 110, and a working table 130. Large envelopes 9 are stacked together in a container 90. The container 90 moves on a roller conveyor 170. The roller conveyor 170 has a plurality of rollers 171, a pair of frames 172 where the rollers 171 are arranged, a driving means (not shown) for rotating the rollers 171, and a guide rail 173 for guiding the container 90. The roller conveyor 170 is provided on top of a base 174. The roller conveyor 170 conveys the container 90 automatically to the envelope discharging apparatus 100.

The movable plate 110 has a bottom plate 111, a side plate 112, and a lock plate 113, which are formed of metal or resin. An end portion of the bottom plate 111 is rotatably connected to the frames 172 on the working table 130 side. The lock plate 113 is formed at the upper end of the side plate 112. The lock plate 113 prevents the container 90 from moving toward the working table 130 side when the movable plate 110 is tilted.

A distal end portion 121 of the air cylinder 120 is rotatably mounted to the central portion of the bottom plate 111. An air cylinder main body portion 122 is movably mounted to the base 174 of the roller conveyor 170. The air cylinder 120 moves the distal end portion 121 to tilt the movable plate 110 by approximately 85 degrees toward the working table 130. The air cylinder 120 is controlled by the operator. The working table 130 is arranged adjacent to the roller conveyor 170 and connected to the base 174. Further, the working table 130 is connected to a supply portion (not shown) of a sorter.

FIGS. 2A through 2D show an example of how the envelope discharging apparatus 100 described above and the operator operate. In FIG. 2A, the roller conveyor 170 conveys the container 90 accommodating the large envelopes 9 stacked together to a position corresponding to the movable plate 110. The subsequent container 90 is on standby in front of the movable plate 110. An operator 200 makes himself ready to support the large envelopes 90 discharged from the container 90.

In FIG. 2B, the operator 200 manipulates a button switch 123 to operate the air cylinder 120. The air cylinder 120 tilts the movable plate 110 by approximately 85 degrees. The operator 200 supports the large envelopes in the container 90.

In FIG. 2C, the operator 200 tilts the large envelopes 9 to the right. Then, while supporting the large envelopes 9, the operator 200 puts the left hand into the container 90 and holds the large envelopes 9 between both hands.

In FIG. 2D, the operator 200 extracts the large envelopes 9 held between both hands from the container 90, and then places them at the supply portion of the sorter. When, thereafter, the button switch 123 is manipulated, the movable plate 110 and the container 90 are restored to the former positions. The roller conveyor 170 conveys the empty container 90. With this, one cycle of the operation of extracting large envelopes from the envelope discharging apparatus 100 is completed.

As described above, the operator puts his hand into the container 90, extracts the large envelopes 9 from the container 90, and places them at the supply portion of the sorter. It should be noted, however, that the movement of a large number of large envelopes 9 gives the operator a heavy physical burden.

### SUMMARY OF THE INVENTION

It is an object of the present invention to provide an article discharging apparatus that relieves the burden on the operator as mentioned above. To achieve the above object, there is provided, in accordance with the present invention, an article discharging apparatus including a first tilting means for tilting a container, a second tilting means for further tilting the container that has been tilted by the first tilting means, and an article moving means for moving an article, the article moving means being arranged close to the second tilting means. In another aspect of the present invention, there is provided an article discharging apparatus including a tilting means for tilting a container, and an article moving means for moving an article, the article moving means being arranged close to the tilting means. Further, the tilting means includes a container moving means, a container fixing means, and a shutter portion for opening/closing at least a part of a container opening. In still another aspect of the present invention, there is provided an article discharging apparatus including a tilting means for tilting a container, and a mechanism for pushing out articles through a through-hole at the bottom of the container. Further, the tilting means includes a member accommodating the container, and a means for pushing a bottom portion of the member to tilt the member.

### BRIEF DESCRIPTION OF THE DRAWINGS

The above and other objects, features and advantages of the present invention will become apparent form the following detailed description when taken with the accompanying drawings in which:

FIG. 1A and FIG. 1B are a front view and a side view, respectively, of an example of a conventional large envelope extracting apparatus;

FIGS. 2A through 2D illustrate an example of how the apparatus shown in FIGS. 1A and 1B is operated;

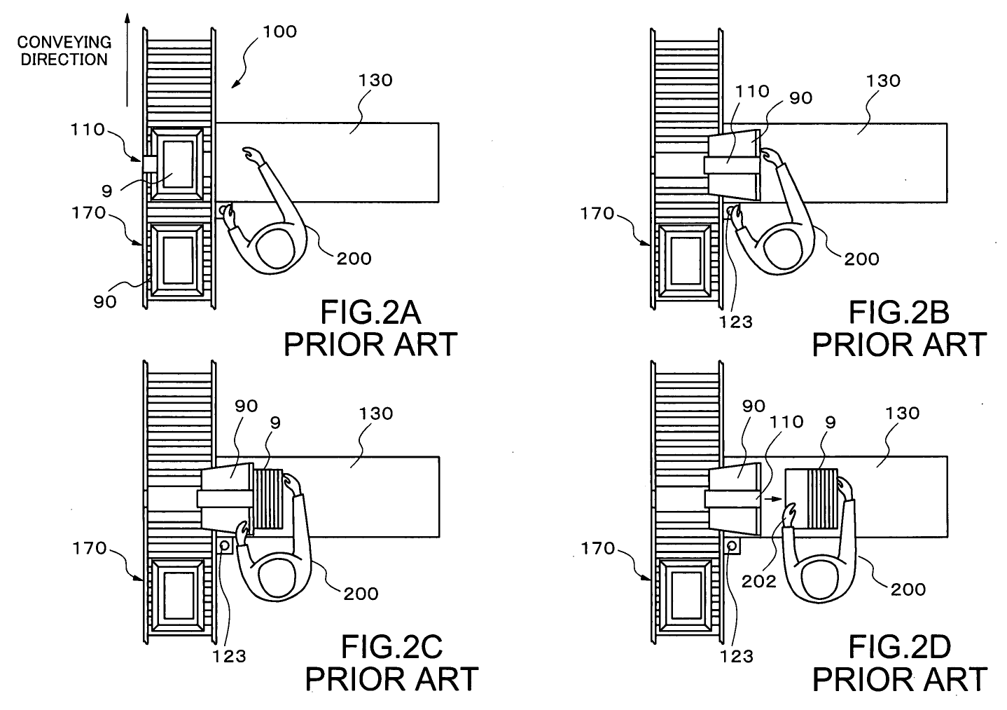

FIG. 3 is a side view of an article discharging apparatus according to a first exemplary embodiment of the present invention;

FIG. 4 is a plan view of the article discharging apparatus of the first exemplary embodiment of the present invention;

FIGS. 5A through 5G illustrate an example of how the article discharging apparatus and an operator work;

FIG. 6 is a side view of an article discharging apparatus according to a second exemplary embodiment of the present invention;

FIG. 7 is a plan view of the article discharging apparatus of the second exemplary embodiment of the present invention;

FIGS. 8A through 8G illustrate an example of how the article discharging apparatus of the second exemplary embodiment works;

FIG. 9 is a side view of an article discharging apparatus according to a third exemplary embodiment of the present invention; and

FIG. 10A and FIG. 10B are a front view and a side view, respectively, of an article discharging apparatus according to a fourth exemplary embodiment of the present invention.

### DETAILED DESCRIPTION OF THE PREFERRED EMBODIMENTS

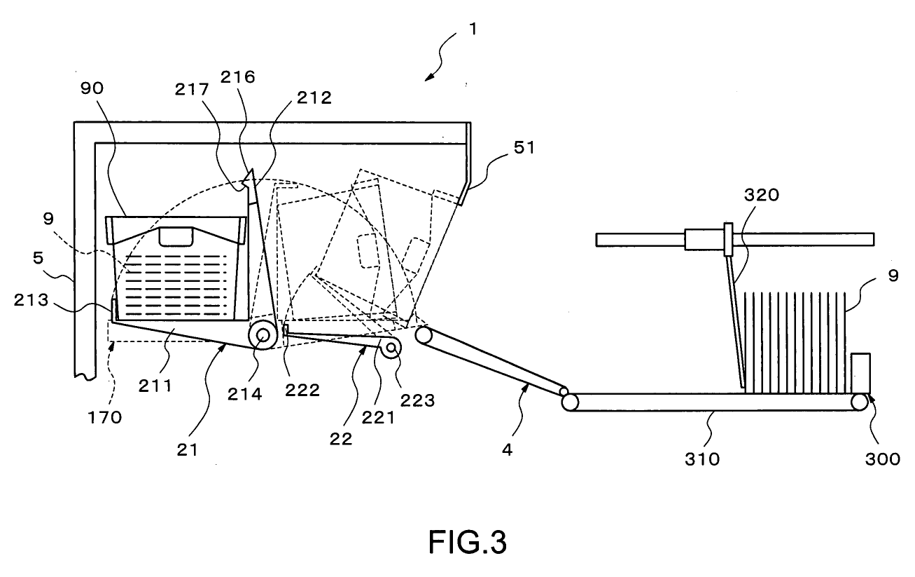

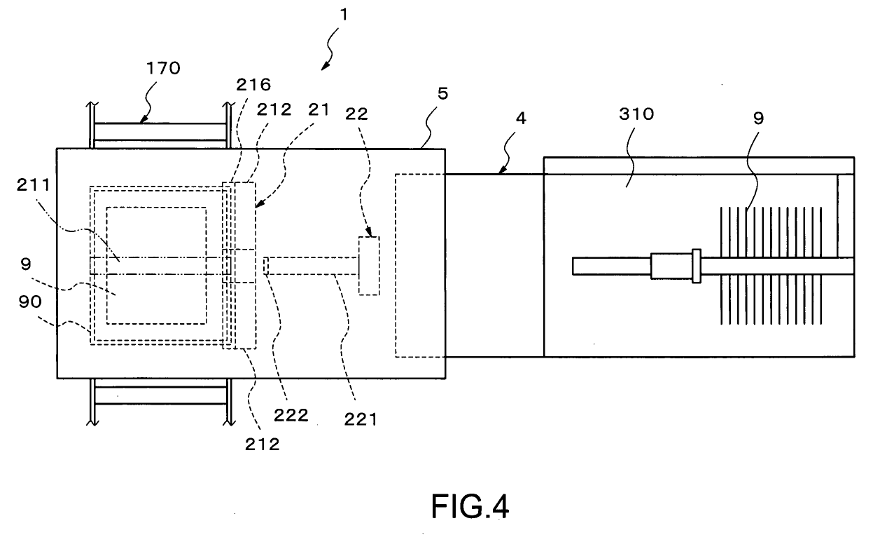

Preferred exemplary embodiments of an article discharging apparatus of the present invention will be described below. FIG. 3 is a side view of an article discharging apparatus 1 according to a first exemplary embodiment of the present invention. FIG. 4 is a plan view of the article discharging apparatus 1 of this embodiment. In this embodiment, the articles to be discharged are large envelopes 9. The article discharging apparatus 1 is equipped with a rotary member 21 for tilting a container 90 capable of accommodating the large envelopes 9, and a rotary member 22 for further tilting the container 90 tilted by the rotary member 21. Further, the article discharging apparatus 1 is equipped with a belt conveyor 4 on which the large envelopes 9 discharged from the container 90 move.

The rotary member 21 has a bottom plate 211 and a side plate 212. The side plate 212 is connected to the bottom plate 211 at an angle of approximately 90 degrees. The bottom plate 211 and the side plate 212 rotate in conjunction with each other around a rotation shaft 214. In this embodiment, the bottom plate 211 and the side plate 212 rotate clockwise by approximately 85 degrees. The bottom plate 211 has at its distal end a lock plate 213. To enable the bottom plate 221 of the rotary member 22 to rotate, the side plate 212 is divided into two portions. Alternatively, the side plate 212 is formed in a U-shaped configuration. The side plate 212 has at its distal end a lock portion 217. In this embodiment, the lock portion 217 has a substantially triangular sectional configuration. In the lock portion 217, a slope 216 on the distal end portion side of the side plate 212 facilitates the movement of the large envelopes from the tilted container 90 onto the belt conveyor 4.

The rotary member 22 has a bottom plate 221. The bottom plate 221 has at its distal end a lock plate 222. The bottom plate 221 rotates around a rotation shaft 223. At this time, the bottom plate 221 passes the middle portions of the two portions of the side plate. 212. The bottom plate 221 rotates by a predetermined angle, and further tilts the tilted container 90 situated on the side plate 212 by a predetermined angle.

A casing 5 is arranged around the rotary members 21 and 22. At the forward end of the casing 5, there is formed a plate-like lock portion 51. The plate-like lock portion 51 prevents the container 90 tilted by the rotary member 22 from further rotating or moving.

When the container 90 is locked by the plate-like lock portion 51, the belt conveyor 4 is arranged close to the container 90. The upper surface of the belt conveyor 4 is inclined. Thus, the large envelopes 9 discharged from the container 90 can move easily. The operator supports the large envelopes by hand, and causes them to move on the belt conveyor 4. Further arranged adjacent to the belt conveyor 4 are a belt conveyor 310 and a support portion 320. The support portion 320 can move over the belt conveyor 310 along a guide. The operator supports the large envelopes 9 by the support portion 320, and causes them to move on the belt conveyor 310, guiding them to a sorter (not shown) by way of a support portion 300. The belt conveyor 4 may or may not have a driving means. Instead of the belt conveyor 4, it is also possible to use a plate member with a smooth surface.

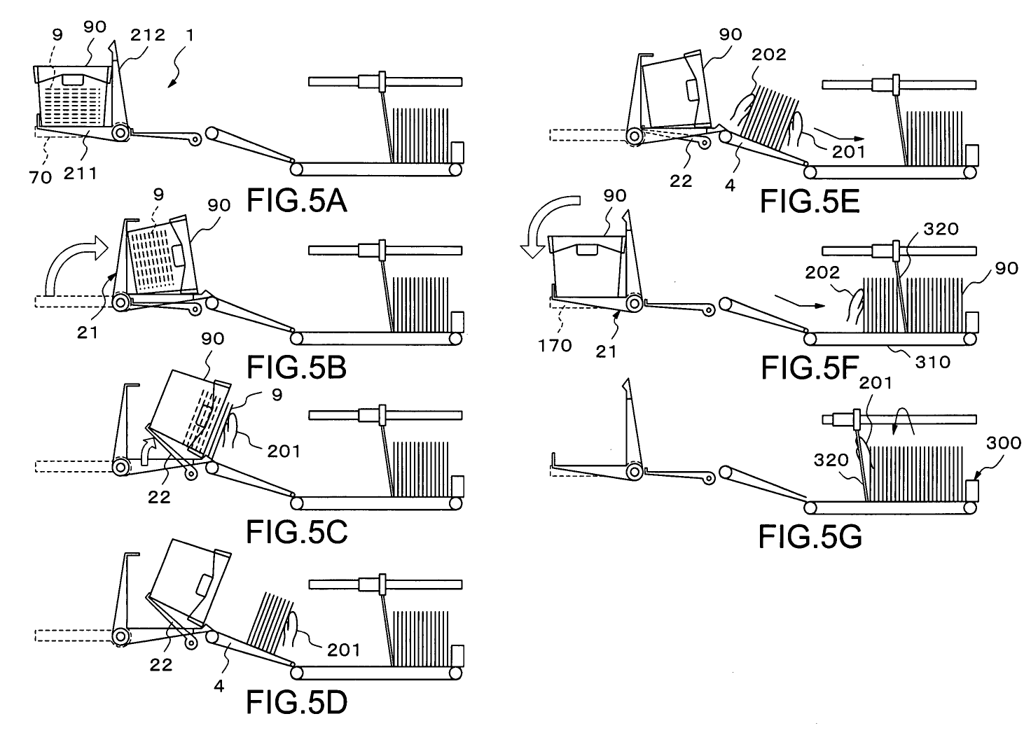

FIGS. 5A through 5G illustrate an example of the way the article discharging apparatus 1 and the operator work. In FIG. 5A, a roller conveyor 170 conveys the container 90 accommodating the large envelopes 9 stacked together to the position of the bottom plate 211. When, in FIG. 5B, the operator 200 depresses a button switch (not shown) an air cylinder (not shown) operates to rotate the bottom plate 211 by approximately 85 degrees. The container 90 is situated substantially sidewise on the side plate 212. At this time, the large envelopes 9 in the container 90 are standing substantially upright. In FIG. 5C, the rotary member 22 further rotates the container 22 by approximately 35 degrees. Here, the operator supports the large envelopes 9 being discharged with his right hand 201. In FIG. 5D, while supporting the large envelopes 9 with the right hand 201, the operator transfers all the large envelopes 9 onto the belt conveyor 4. In FIG. 5E, the operator manipulates the button switch to restore the rotary member 22 to its former position. The operator supports the large envelopes 9 with the right hand 201 and the left hand 202. Since the large envelopes 9 move downwardly on the slope of the belt conveyor 4, the burden on the operator is relieved. In FIG. 5F, the rotary member 21 restores the empty conveyor 90 to its former position on the roller conveyor 170. The operator transfers the discharged large envelopes 9 onto the belt conveyor 310, and moves them to a support portion 320. In FIG. 5G, the operator moves the support portion 320 to the left-hand side of the large envelopes 9. With this, the setting of the large envelopes 9 at the supply portion 300 of the sorter is completed. At this point in time, one cycle of the operation of discharging the large envelopes 9 from the article discharging apparatus 1 is completed. In the above operation, the large envelopes 90 are discharged smoothly from the container 90, so that the burden on the operator is substantially relieved.

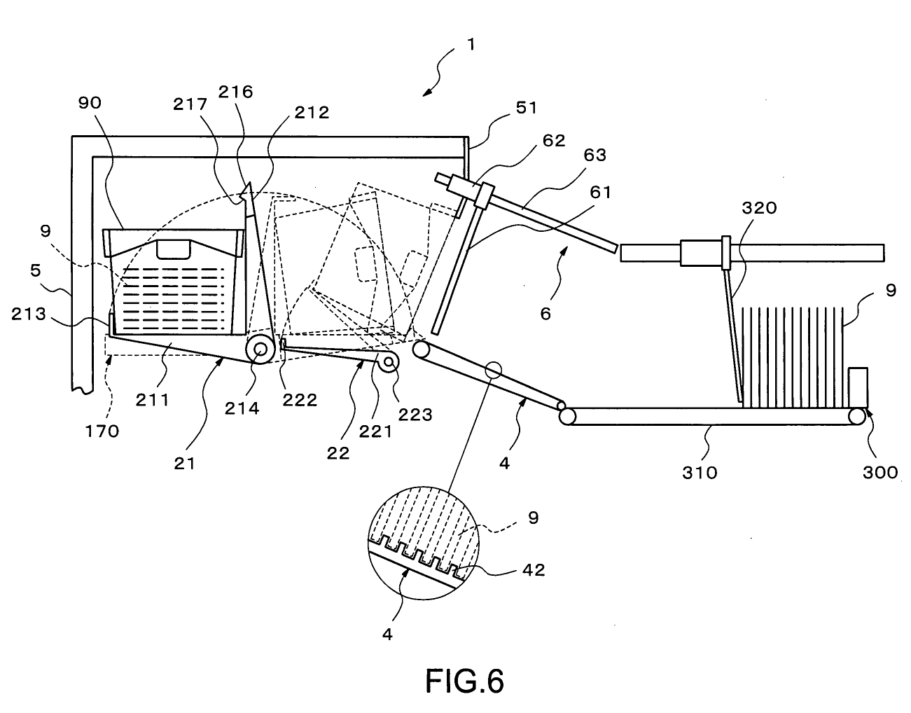

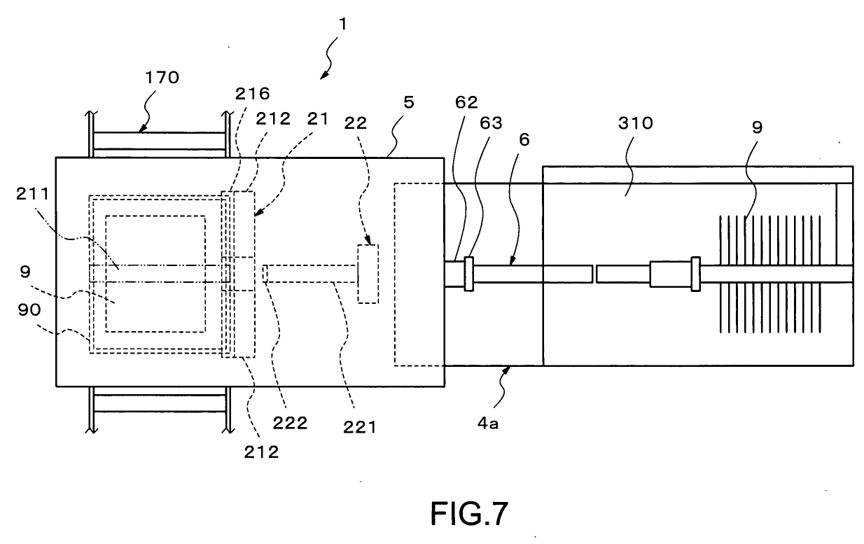

FIG. 6 is a side view of the article discharging apparatus 1 according to a second exemplary embodiment of the present invention. FIG. 7 is a plan view of the article discharging apparatus 1. The basic construction of the article discharging apparatus 1 is the same as that of the article discharging apparatus 1 as shown in FIG. 3 and FIG. 4. In the article discharging apparatus 1 of this embodiment, a support means 6 is arranged above the belt conveyor 4. The support means 6 has a movable portion 62, a guide portion 63, and a support bar 61. The movable portion 62 and the guide portion 63 constitute a linear motor. The support bar 61 is rotatably mounted to the movable portion 62. The guide portion 63 is arranged substantially parallel to the upper surface (inclined surface) of the belt conveyor 4. The support bar 61 supports the large envelopes 9 discharged, and moves them on the belt conveyor 4. There is no need for the operator to support the large envelopes 9. The support means 6 can be formed by utilizing a ball screw, and an elastic member such as a spring or rubber.

As shown in the enlarged portion of FIG. 6, in the second exemplary embodiment, there are formed a plurality of linear protrusions 42 on the surface of the belt of the belt conveyor 4. The linear protrusions 42 can lock the large envelopes 9 discharged from the container 90. Thus, the large envelopes 9 stacked together are reliably moved. The belt conveyor 4 having linear protrusions is equivalent to a belt conveyor having linear grooves in terms of function and appearance. When the belt conveyor 4 has a power portion, it is possible to synchronize the operations of the linear motor and the belt conveyor 4.

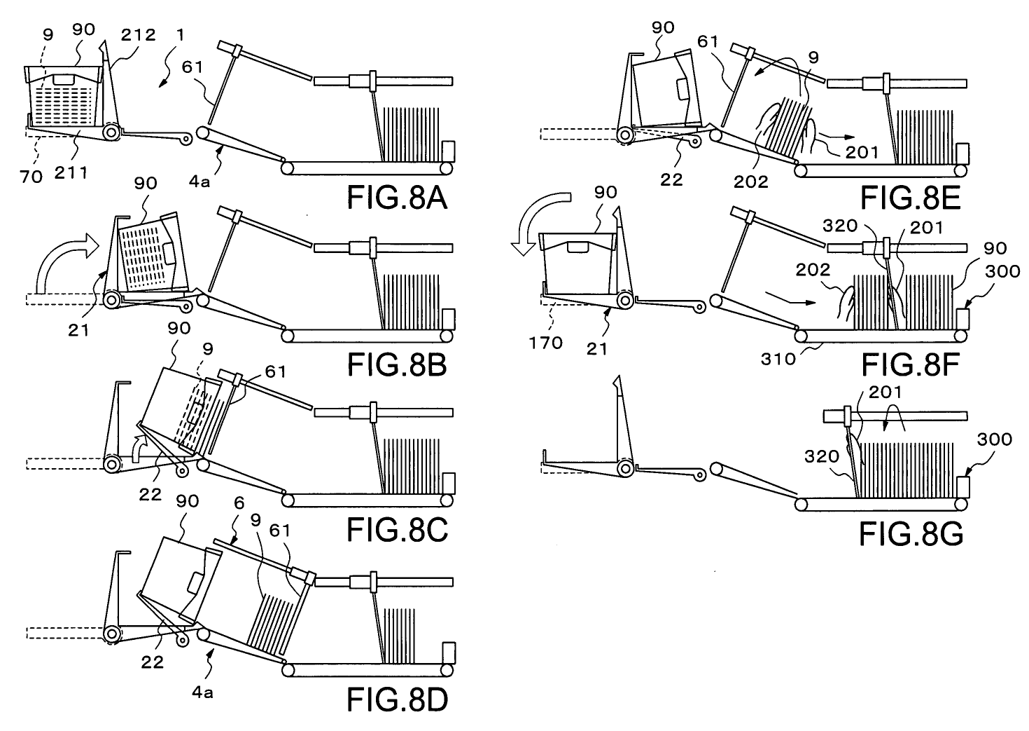

FIGS. 8A through 8G show an example of how the article discharging apparatus 1 shown in FIGS. 6 and 7 operates. In FIG. 8A, the roller conveyor 170 conveys the container 90 accommodating the large envelopes 9 stacked together to the position of the bottom plate 211. At this time, the support bar 61 is situated on the roller conveyor 170 side. In FIG. 8B, the operator 200 depresses the button switch (not shown) to rotate the bottom plate 211 by approximately 85 degrees. The tray 90 is situated on the side plate 212 substantially sidewise. At this time, the large envelopes 9 in the container 90 are standing substantially upright. In FIG. 8C, the rotary member 22 further rotates the container 90 by approximately 35 degrees. At this time, the support bar 61 supports the large envelopes 9 discharged from the container 90. In FIG. 8D, the support means 6 moves the support bar 61 downwards along the belt conveyor 4. The large envelopes 9 move sequentially on the belt conveyor 4 while supported by the support bar 61. In FIG. 8E, the operator supports the large envelopes 9 with the right hand 201, and rotates the support bar 61 with the left hand 202. Subsequently, the operator moves the movable portion 62 to the roller conveyor 170 side, and restores the support bar 61 to its former position. Further, the operator supports a plurality of large envelopes 9 stacked together with both hands. In FIG. 8F, the rotary member 21 restores the empty container 9 to its former position on the roller conveyor 170. The operator transfers the discharged large envelopes 9 onto the belt conveyor 310, and moves them to the support portion 320. In FIG. 8G, the operator moves the support portion 320 to the left-hand side of the large envelopes 9. At this time, the setting of the large envelopes 9 at the supply portion 300 of the sorter is completed. In the above operation, the burden on the operator is further relieved.

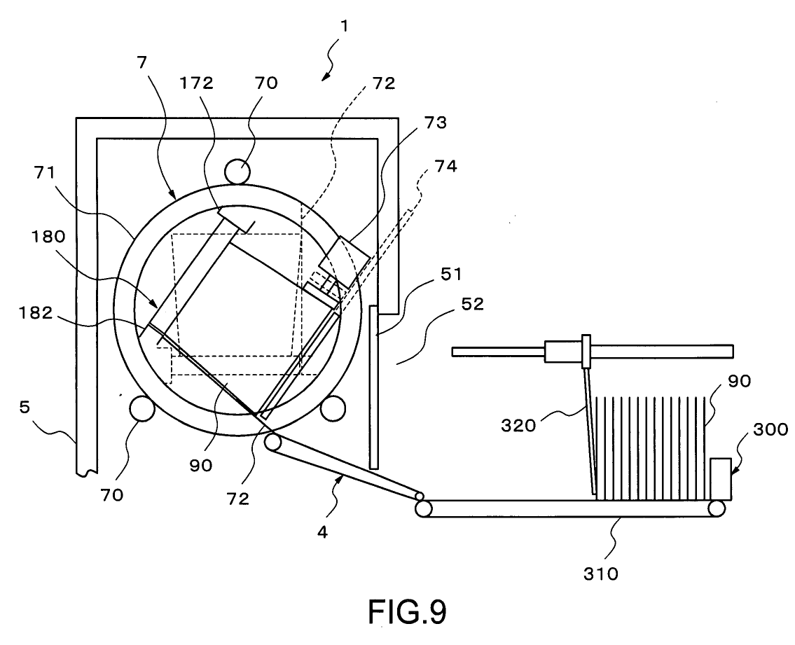

FIG. 9 is a side view of an article discharging apparatus 1 according to still another exemplary embodiment of the present invention. The article discharging apparatus 1 of this embodiment has a rotating means 7 for rotating the container 90 together with a roller conveyor 180. The rotating means 7 has a pair of rotation rings 71, which are supported by roller bearings 70. To rotate the rotation rings 71, it is possible to use a well-known means (such as a motor, a transmission belt, or a gear). On either side of the rotation rings 71 there is arranged a predetermined support means (not shown) in order that the rotation rings 71 may not move in the direction of the central axis. The roller conveyor 180 is arranged independently of the conveyor for conveying the container 90. A frame 182 of the roller conveyor 180 is connected to the inner side portions of the rotation rings 71. Connected to the frame 182 of the roller conveyor 180 are a slide plate 72, an electromagnetic solenoid 73 for retaining the container, and a shutter 74. These components also rotate with the rotation rings 71. When the rotating means 7 tilts the container 90 by, for example, approximately 125 degrees, the forward end portion of the slide plate 72 reaches an end portion of the belt conveyor 4, and partially overlaps the same. The electromagnetic solenoid 73 presses the container 90 situated on the roller conveyor 180 against the slide plate 72 to secure the container 90. The shutter 74 is opened and closed by a linear motor or the like (not shown). The shutter 74 covers the opening of the container 90, making it possible to temporarily stop the discharge of the large envelopes. The roller conveyor 180 has a motor (not shown) The length of the roller conveyor 180 is larger than the width of the belt conveyor 4.

A casing 5 is arranged in the periphery of the rotating means 7. The casing 5 covers the entire rotating means 7 except for those portions which are necessary for the conveyance of the container 90, the discharge of the large envelopes 9, etc. The casing 5 has a discharge outlet 52 for the large envelopes 9, and a shutter 51 for opening and closing the discharge outlet 52.

An example of the operation of the article discharging apparatus 1 of FIG. 9 will be described below. When the container 90 accommodating the large envelopes 9 comes to the roller conveyor 180, the roller conveyor 180 moves the container 90 to a position substantially at the center of the roller conveyor 180, and stops it there. Subsequently, the electromagnetic solenoid 73 for retaining the container presses the container 90 against the slide plate 72 to secure the container in position. At this time, the shutters 51 and 74 are closed. The rotation rings 71 rotate clockwise by approximately 125 degrees, and the upper end portion of the slide plate 72 comes into contact with the upper end portion of the belt conveyor 4. The large envelopes 9 in the container 90 move toward the shutter 74 while in the stacked state. When the center of gravity of the container 90 accommodating the large envelopes 9is brought close to the center of the rotation rings 71, the impact when the large envelopes 9 collide with the shutter 74 is mitigated.

Next, the shutter 51 is opened. When the operator brings the right hand close to the shutter 74, a sensor operates, and the shutter 74 is opened automatically. The operator supports the large envelopes 9 discharged from the container 90 by hand, and transfers them onto the belt conveyor 4. Thereafter, as in the operation of the above-described other embodiment, the operator sets the large envelopes 9 at the supply portion 300. When the operator manipulates the button switch, the shutter 74 is closed, and then the shutter 51 is closed. Subsequently, the rotation rings 71 rotate counterclockwise by approximately 125 degrees to return to the former position. The electromagnetic solenoid 73 for retaining the container is restored to the initial position, and the roller conveyor 180 carries the empty container 90 out of the casing 5. In this embodiment also, the burden on the operator is relieved.

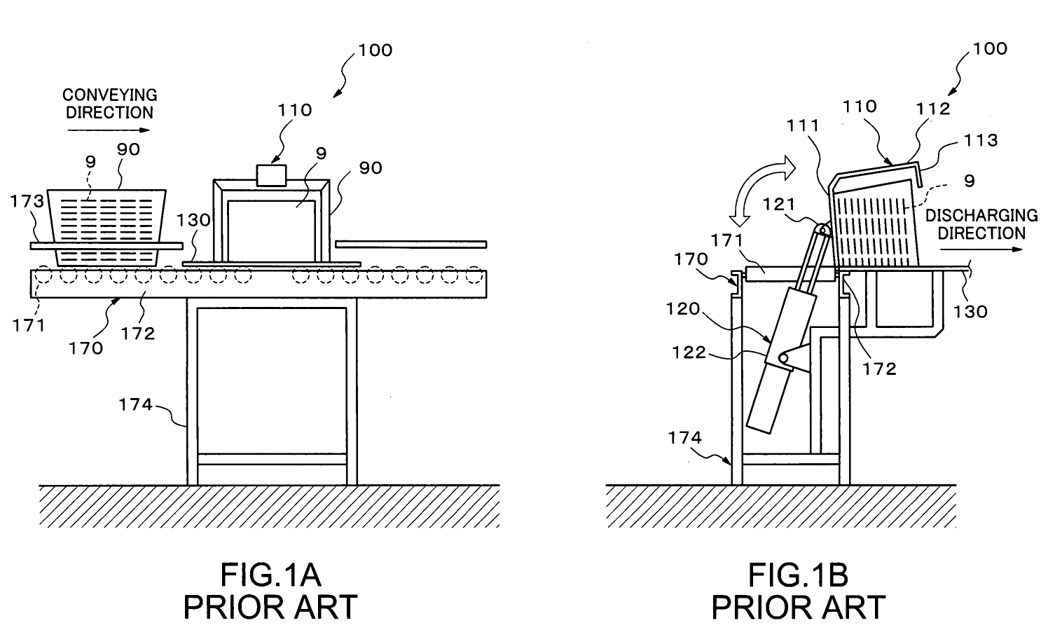

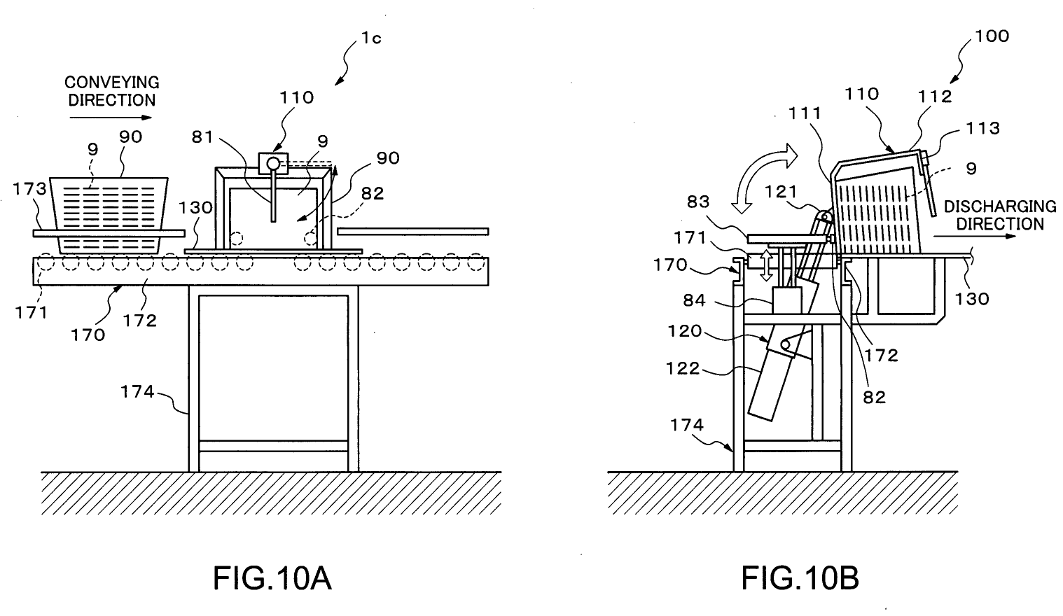

FIGS. 10A and 10B are a front view and a side view, respectively, of an article discharging apparatus according to still another exemplary embodiment of the present invention. The basic construction of the article discharging apparatus 1 of this embodiment is the same as that of the conventional apparatus as shown in FIGS. 1A and 1B. In this embodiment, however, a through-hole is formed in the bottom surface of the container 90. Further, the base 174 has an air cylinder 83, and another air cylinder 84 for vertically moving the air cylinder 83. A rod 82 of the air cylinder 83 passes through the through-hole of the bottom surface of the tilted container 90 to push out the large envelopes 9. In this embodiment, the container 90 has two through-holes, and two rods 82 operate simultaneously to push out the large envelopes 9. The operation of the air cylinder 122 tilting the container 90 can be synchronized with the operation of the air cylinders 83 and 84. There is no need for the operator to put his hand in the container 90 and extract the large envelopes 9. As a result, a reduction in burden is achieved.

In the present invention, apart from large envelopes, the articles to be accommodated in the container 90 include small envelopes, postcards, etc.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

Further, it is the inventor's intent to refrain all equivalents of the claimed invention even if the claims are amended during prosecution.

What is claimed is:

1. An apparatus for discharging an article in a container, comprising:
a first tilting means for tilting the container;
a second tilting means for further tilting the container that has been tilted by the first tilting means; and
an article moving means for moving the article, the article moving means being arranged close to the second tilting means.

2. An apparatus according to claim 1, wherein the article moving means comprises an inclined surface.

3. An apparatus according to claim 1, wherein the article moving means comprises a belt conveyor.

4. An apparatus according to claim 3, wherein the belt conveyor has a plurality of grooves formed in a belt of the belt conveyor.

5. An apparatus according to claim 1, further comprising an article supporting means for supporting the article discharged from the container.

6. An apparatus according to claim 5, wherein the article supporting means comprises a support portion directly supporting the article, a guide portion guiding the support portion, and a power portion for moving the support portion.

7. An apparatus for discharging an article in a container, comprising:
a tilting means for tilting the container; and
an article moving means for moving the article, the article moving means being arranged close to the tilting means,
wherein the tilting means comprises a container moving means, a container fixing means, and a shutter portion for opening and closing at least a part of an opening of the container.

8. An apparatus according to claim 7, wherein the container moving means comprises a power portion for moving the container.

9. An apparatus according to claim 7, wherein the tilting means comprises a side plate, and wherein the container fixing means presses the container against the side plate.

10. An apparatus according to claim 7, wherein the article moving means comprises an inclined surface.

11. An apparatus according to claim 7, wherein the article moving means comprises a belt conveyor.

12. An apparatus for discharging an article in a container, comprising:
a tilting means for tilting the container; and
a mechanism for pushing out the article through a through-hole in a bottom portion of the container,
wherein the tilting means comprises a member for accommodating the container, and a means for pushing a bottom portion of the member to tilt the member.

13. An apparatus according to claim 12, wherein the member comprises a movable support portion supporting the article at a position corresponding to an opening of the container.

14. An apparatus according to claim 12, wherein the member can rotate around a part of the member.
